(19) United States
(12) Patent Application Publication
(10) Pub. No.: US 2017/0016702 A1
(43) Pub. Date: Jan. 19, 2017

(54) GAS GENERATOR

(71) Applicant: Benteler Steel/Tube GmbH, Paderborn (DE)

(72) Inventors: Thomas Vietoris, Paderborn (DE); Jozef Balun, Paderborn (DE); Olivier Depierreux, Paderborn (DE)

(21) Appl. No.: 15/211,407

(22) Filed: Jul. 15, 2016

(30) Foreign Application Priority Data
Jul. 17, 2015 (DE) 10 2015 111 680.4

(51) Int. Cl. F42B 3/04; C22C 38/14; C22C 38/12; C22C 38/08; C22C 38/06; A62C 3/08; C22C 38/02; C22C 38/00; B60R 21/264; B64D 25/10; B64G 1/40; F02K 9/60; C22C 38/16; C22C 38/04

(52) U.S. Cl. CPC F42B 3/04; C22C 38/16; C22C 38/14; C22C 38/12; C22C 38/08; C22C 38/06; C22C 38/04; C22C 38/02; C22C 38/002; C22C 38/001; B60R 21/264; B64D 25/10; B64G 1/40; F02K 9/60; A62C 3/08; B60R 2021/26082

(57) ABSTRACT

The present invention relates to a gas generator, comprising a comprising a tubular element (10) with high low-temperature toughness. The gas generator is characterized in that the tubular element (10) has a ductile fracture behavior at temperature to at least −196° C., the tubular element (10) has a minimal tensile strength of 650 MPa, the tubular element (10) has a cubic face-centered austenitic structure with at least 90 area percentage and the tubular element (10) consists of a steel alloy which has a manganese content of at least 14.0 wt %

### REFERENCE TO PENDING PRIOR PATENT APPLICATION

This patent application claims benefit of German Patent Application No. 10 2015 111 680.4 filed Jul. 17, 2015, which patent application is hereby incorporated herein by reference.

### FIELD OF THE INVENTION

The present invention relates to a gas generator, which at least comprises a tubular element.

### BACKGROUND OF THE INVENTION

To date, gas generators are manufactured from carbon steels and have more or less satisfactory low-temperature toughness. Carbon steels change their fracture behavior at low temperatures from a ductile fracture to a brittle fracture. The temperature where 50% brittle fracture occurs is referred to as transition temperature.

Disadvantages of the known gas generators are thus the brittle failure at low temperatures and the compromise which has to be made with known gas generators between strength, toughness and formability.

In addition, a steel tube made of a steel alloy with low carbon content is known, for example, from US 2005/0076975 A1 which has an ultra high strength and excellent toughness at low temperatures. Also in DE 101 43 073 A1 a steel composition is described, which is used for manufacturing a steel tube for an inflation device for storing of gas for a vehicle occupants protection arrangement. The steel tube has a high toughness at low temperatures. A disadvantage of these known steel alloys is that due to the large number of different alloying elements the reliable manufacturing of the steel alloy and thereby the setting of the desired properties is difficult.

The present invention has the object of providing a gas generator, which at least reduces the disadvantages of the prior art.

### SUMMARY OF THE INVENTION

The invention is based on the finding that this object can be achieved by a gas generator which comprises at least a tubular element, wherein the tubular element is made of a material, which has an austenitic structure.

According to the invention the object is achieved by a gas generator comprising a tubular element with high low-temperature toughness. The gas generator is characterized in that the tubular element has a ductile fracture behavior at temperature to at least −196° C., a minimal tensile strength of 650 MPa, in particular 700 MPa, the tubular element has a cubic face-centered austenitic structure with at least 90 area percent and the tubular element consists of a steel alloy which has a manganese content of at least 14.0 wt %.

A gas generator according to the invention denotes a component, in which gas is stored or generated and from which the gas can be output at high velocity. The gas generator according to the present invention is preferably a cold gas generator. A cold gas generator consists of a gas storage, in which gas is stored under high pressure, and an activator. The gas generator is closed by a membrane. Upon activating the gas generator the membrane is destroyed, in particular by means of explosive charge, and the gas can stream out of the gas storage. Alternatively, the gas generator according to the invention can be a hybrid gas generator. This is a combination of a pyrotechnical gas generator and a cold gas generator. With a hybrid gas generator besides the pressure storage for the gas, a pyrotechnical set is provided in addition for gas generation. As the tubular element of such a gas generator serves as cold gas container, the requirements as to low-temperature toughness are particularly high.

According to the invention, the gas generator comprises a tubular element with high low-temperature toughness. The tubular element may serve as gas pressure container and/or reaction chamber of the gas generator. In particular, the tubular element may also be referred to as inflator. The tubular element has high low-temperature toughness. This means that the material of the tubular element has a minimal value of notch impact work of 27 Joule (J) with V-specimen according to EN ISO 148 at a temperature of -60° C. or even lower temperatures.

According to the invention, the gas generator is characterized in that the tubular element has a ductile fracture behavior at a temperature to at least −196° C. This means that also at a temperature down to −196° no brittle fracture or at least less then 50 percent (%) brittle fracture is present in the notch impact specimen.

Furthermore, the tubular element has a minimal tensile strength of 650 megapascal (MPa), in particular 700 MPa.

According to the invention, the tubular element has a cubic face-centered austenitic structure with at least 90 area percent. This means that at least 90 area percent are present as austenitic structure.

According to the invention, the tubular element consists of a steel alloy which has a manganese content of at least 14.0 wt %.

In contrast to resentments from the prior art, such as for example in US 2005/0076975 A1, that a too high manganese content leads to a decrease of toughness of a material and is too susceptible to hydrogen embrittlement and stress corrosion cracking to be for example used in an air bag, it has been found according to the invention that a manganese content of more than 14 wt % reliably generated an austenitic structure with a cubic face-centered structure that excellently provides the properties, which are for example necessary for an airbag. In addition, due to the high content of manganese, hardening and tempering of the tubular element, which is normally required for tubular elements of a gas generator, is not necessary with the steel alloy which is used according to the invention.

According to the invention thus at least the tubular element of the gas generator consists of austenitic steel. The steel alloy which is at least being used for the tubular element according to the invention is a FeMn steel with a manganese content of more than 14 wt %, preferably more than 17 wt % and for example more than 20 wt %. The steel alloy which is used can also be referred to as high manganese steel. The high manganese steel which is being used according to the invention also has TWIP (Twinning Induced Plasticity)-properties. This means that upon plastic deformation due to a relatively low stacking fault energy an intense twin formation occurs.

With the gas generator according to the invention thus due to its properties, bursting or a different damaging of the tubular element can be avoided. In addition, besides achieving a cubic face-centered austenitic structure, due to the usage of large amounts of manganese also a weight reduction can be achieved. This is mainly due to the lower density, which manganese has. In addition, the weight of the gas generator and in particular of the tubular element can be further reduced, since due to the mechanical characteristics values of the material of the tubular element, in particular the tensile strength and low-temperature toughness, also a smaller wall thickness of the tubular element can be sufficient.

According to an embodiment, the steel alloy from which at least the tubular element is manufactured comprises besides iron and impurities resulting from smelting, the following alloying elements in wt %:
C>0.03
Mn>14.0
Al>0.03
Optionally:
Si>0.03
P<0.03 and/or
S<0.001.

By addition of carbon, the tensile strength of the material of the tubular element can be adjusted or improved, respectively. In addition, by adding carbon, the structure of the material is stabilized in its austenitic state. The carbon content of the steel alloy can for example be in the range of 0.3-0.7 wt % and preferably in the range of 0.1-1 wt %.

Moreover, by the addition of aluminum a grain refinement can be achieved, which further improves the strength and toughness of the material of the tubular element. In addition, aluminum contributes to avoiding hydrogen embrittlement of the material. The aluminum content may for example be more than 1.0 wt %.

According to a preferred embodiment, at least the tubular element of the gas generator consists of steel alloy which besides iron and of impurities resulting from smelting consists of the following alloying elements indicated in weight percent:

### C 0.1-1%

### Si<2.5%

### Mn≧14%

### Al>1%

### B<0.005%

### Ni<2.00%

### Cu<2.00%

### Nb<0.30

### Ti<0.30%

### V<0.30%

### N<0.60%

### P<0.01%

### S<0.01%

Even with the silicon amount begin limited to maximum of 2.5% a good formability, breaking elongation and high tensile strength can be achieved.

The amount of Boron which is added to the steel alloy is limited to a maximum of 0.005 wt %. In particular, the Boron content is chosen to ensure that the solidus temperature is not too low which would result in a postponed solidification.

According to the present invention also a gas generator is provided wherein the tubular element has a minimal tensile strength of 1,100 MPa.

It is specifically preferred, that the tubular element has a ductile fracture behavior after cold forming of the tubular element by at least 2%, in particular at least 10%. Since even after cold forming of the tubular element a brittle fracture is prevented, the tubular element can be brought into the shape which is required for its use in the gas generator, for example can be tapered at the end areas. According to one embodiment cold forming thus is the modification of the outer diameter of the tubular element. This modification amounts to preferably between 5 and 30 percent of the outer diameter in a length section of the tubular element, in particular 10 to 15 percent in at least an end-sided length section of the tubular element.

In the inventive gas generator, the tubular element has a ductile fracture behavior at a temperature to at least −196° C. It is specifically preferred that according to the invention also to <=−200° C. still a ductile fracture behavior exists. According to the present invention thus a gas generator with good low-temperature toughness is provided, in particular a gas generator which does not have a transition temperature and even at very low temperatures down to at least −196° C., preferably to <=−200° C. does not show brittle failure.

According to a preferred embodiment, the gas generator is a gas generator for vehicle occupants protection devices or passenger protection device, in particular an airbag. The gas generator may be a cold gas generator or a hybrid gas generator. In these gas generators at least one tubular element is provided which in particular serves as pressure storage and/or expansion chamber for gas. On these tubular elements high forces act spontaneously, which the material of the tubular element has to withstand, in order to be able to prevent bursting of the tubular element.

Since no brittle fracture risk exists with the material which is used according to the invention, when actuating the airbag, the risk of injury of the occupants or the surrounding of a vehicle is also minimized. In particular, an injury of the occupants of the vehicle by splinters from the gas generator and in particular the tubular element can be prevented, as splintering can be excluded with the alloy which is used according to the invention. With the present invention namely a splinter-proof gas generator is provided.

Alternatively, the gas generator may be used for different purposes. The gas generator may be, for example, a gas generator, in particular an aerosol generator, for a fire extinguisher, for example for air plane engines. In addition the inventive gas generator can be applied as a propellant cartridge or as an actuator of an ejection seat. Finally, the gas generator may be also used for engine modules and/or position control for spacecrafts.

Also in these areas of application of the inventive gas generator, the advantages of the present invention, in particular the combination of high low-temperature toughness, high tensile strength and low weight can be used advantageously.

According to a preferred embodiment, the tubular element of the gas generator is a seamless pipe. By using a seamless pipe, the risk of failure of the tubular element of the gas generator can be reduced further. Such a seamless pipe is hot-rolled, for example according to the Mannesmann-Erhard-Method, and subsequently preferably at least once cold drawn to final dimensions. Alternatively a hot-rolled pipe may also be extruded instead of being drawn. It can also be provided that instead of a hot-rolled pipe, a welded pipe is used as tubular element, in particular for pyrotechnically ignited gas generators.

According to one embodiment, the seamless pipe which may be used as the tubular element for the gas generator may be manufactured by the following method:

Providing a billet, hot-piercing of the billet, hot-rolling on push bench, diagonal rolling and/or stretch-reducing rolling and cold drawing.

The method may comprise further steps of punching a filling hole into the tubular element and/or treatment of the ends of the tubular element by for example tapering or thickening of the ends.

A heat treatment procedure, namely hardening and tempering is not necessary and is preferably omitted.

The invention will hereinafter be explained again with reference to the attached figures. Herein:

### BRIEF DESCRIPTION OF THE DRAWINGS

FIG. 1 shows a schematic depiction of the construction of an embodiment of the gas generator according to the invention; and

FIG. 2: shows a schematic depiction of the construction of a further embodiment of the gas generator according to the invention.

### DETAILED DESCRIPTION OF THE INVENTION

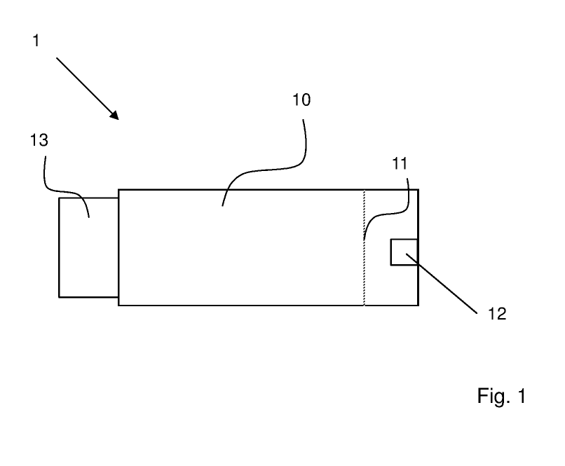

In the embodiment shown in FIG. 1 the gas generator 1 comprises a tubular element 10, which is closed at one end. In the area of this end, the tubular element 10 is covered by a membrane 11. At the opposite end of the tubular element 10 a diffusor 13 adjoins. In the diffusor 13 gas outlet openings (not shown) are provided. By means of an igniter 12 which is arranged in the tubular element 10, the gas which is stored in the tubular element under pressure can be expanded. Thereby, the membrane 11 is destroyed and the gas streams into the diffusor 13 and from there is released via the gas outlet openings. The gas is for example let into an inflatable part of an airbag (not shown).

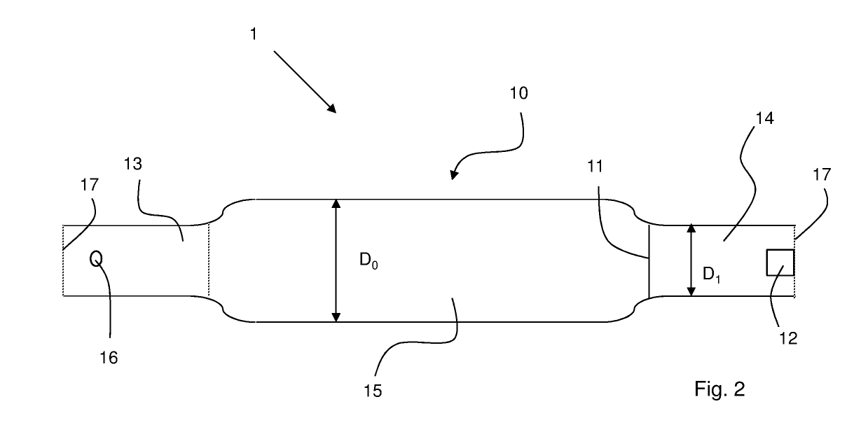

In FIG. 2 a further embodiment of the gas generator 1 according to the invention is shown. Also this gas generator 1 comprises a tubular element 10. In the embodiment shown in FIG. 2, the tubular ends are tapered or drawn in. The tapering of the tubular ends may be generated by cold forming. In the depicted embodiment, the tubular ends each have a diameter D₁, which is smaller than the diameter of the tubular element 10 in its middle section. Also in the embodiment shown in FIG. 2, the gas generator has a combustion chamber 14, wherein an ignitor as well as the further pyrotechnical components is provided. At the tubular end the combustion chamber 14 is closed by a plate 17 which is welded thereto. Cold gas storage 15 adjoins to the combustion chamber 14. This is separated from the combustion chamber 14 by the membrane 11, which can also be referred to as bursting plate. The cold gas storage 15 lies in the area of the tubular element 10, which has the larger diameter D₀. The diffusor 13 adjoins to the cold gas storage 15. In FIG. 2 in the area of the diffusor 13 a filling hole 16 is shown. The tubular end of the diffusor 13 is welded with a plate 17, that is it is closed thereby.

In the cold gas storage 15 for example a pressure of 580 bar may be present. In the combustion chamber 14, the pressure may increase for example from 580 bar to 1,200 bar when igniting the ignitor. The gas generator 1 according to the invention can reliably withstand this pressure due to its properties.

With the present invention, the tubular element in the usage for airbags, the said fire extinguisher or ejection seats and position control for spacecrafts, is subjected to inner pressure load and potentially to dynamic bursting load. With the inventive gas generator herein a sufficient safety is given due to the low-temperature toughness and strength.

With the gas generator according to the invention and in particular with the manganese steel which is used at least for the tubular element, a high strength can be achieved and the overall weight can be decreased. Furthermore, the gas generator according to the invention provides high reliability even in extreme situations due to the good low-temperature toughness. In particular, a brittle or ductile failure is not does not have to be feared when using the gas generator.

The present invention has a number of advantages. In particular, a brittle failure at low temperatures does not have to be feared. Nevertheless, a high strength, in particular a strength of 700 MPa to 1400 MPa, preferably 1000 MPa or 1100 MPa is achieved. In spite of the high strength the steel alloy which is used for the manufacture of at least the tubular element, has a good formability. In particular, the tubular element can also be attached to the gas generator by cold forming without making the formability more difficult. Finally, the weight of the gas generator can be reduced. Thereby, requirements for lightweight construction can be achieved with a gas generator. By reducing the material consumption for the gas generator, also the higher price of the alloy to be used which is to be expected due to the addition of manganese can be reduced.

### LIST OF REFERENCE NUMBERS

1 gas generator
10 tubular element
11 membrane
12 ignitor
13 diffusor
14 combustion chamber
15 cold gas storage
16 filling hole
17 plate

1. Gas generator, comprising a tubular element (10) with high low-temperature toughness, characterized in that
the tubular element (10) has a ductile fracture behavior at a temperature to at least −196° C.,
the tubular element (10) has a minimal tensile strength of 650 MPa,
the tubular element (10) has a cubic face-centered austenitic structure with at least 90 area percent and
the tubular element (10) consists of a steel alloy which has a manganese content of at least 14.0 wt %.

2. Gas generator according to claim 1, characterized in that the tubular element (10) consists of a steel alloy which has a manganese content of at least 17.0 wt %.

3. Gas generator according to claim 1, characterized in that the steel alloy, of which at least the tubular element (10) of the gas generator consists, comprises besides iron and impurities resulting from smelting, the following alloying elements, indicated in wt %:
C>0.03
Mn>14.0
Al>0.03

4. Gas generator according to claim 3, characterized in that the carbon content of the steel alloy is in the range of 0.3-0.7 wt %.

5. Gas generator according to claim 3, characterized in that the aluminum content of the steel alloy is more than 1.0 wt %.

6. Gas generator according to claim 1, characterized in that the steel alloy of which at least the tubular element of the gas generator consists, consists, besides iron and of impurities resulting from smelting, of the following alloying elements indicated in weight percent:
C 0.1-1%
Si<2.5%
Mn≧14%
Al>1%
B<0.005%
Ni<2.00%
Cu<2.00%
Nb<0.30
Ti<0.30%
V<0.30%
N<0.60%
P<0.01% and
S<0.01%

7. Gas generator according to claim 1, characterized in that the minimal tensile strength of the tubular element (10) is at least 1100 MPa.

8. Gas generator according to claim 1, characterized in that the tubular element (10) has a ductile fracture behavior after cold forming of the tubular element (10) by at least 2%, in particular at least 10%.

9. Gas generator according to claim 8, characterized in that the cold forming is a modification of the outer diameter of the tubular element (10).

10. Gas generator according to claim 1, characterized in that the tubular element (10) has ductile fracture behavior at a temperature to at least −200° C.

11. Gas generator according to claim 1, characterized in that the gas generator (1) is a gas generator for a vehicle occupants protection device or a passenger protection device, in particular an airbag.

12. Gas generator according to claim 1, characterized in that the gas generator (1) is a gas generator for a fire extinguisher for airplane engines, for an actuator of an ejection seat or for position controls for spacecrafts.

13. Gas generator according to claim 1, characterized in that the tubular element (10) is a seamless pipe.
